(19) United States
(12) Patent Application Publication
(10) Pub. No.: US 2017/0185269 A1
(43) Pub. Date: Jun. 29, 2017

(54) Display management solution

(71) Applicant: MULTITOUCH OY, Helsinki (FI)

(72) Inventors: Hannu Anttila, Helsinki (FI); Tommi Ilmonen, Helsinki (FI)

(21) Appl. No.: 15/115,284

(22) PCT Filed: Jan. 21, 2015
(86) PCT No.: PCT/FI2015/050034

§ 371 Date: Jul. 29, 2016

(30) Foreign Application Priority Data
Jan. 31, 2014 (FI) 20145110

(51) Int. Cl. G06F 3/0484; G06F 3/14; G06F 3/0488

(52) U.S. Cl. CPC G06F 3/04845; G06F 3/04886; G06F 3/1454

(57) ABSTRACT

According to an example embodiment of the present invention, there is provided an apparatus comprising a memory configured to store information relating to a representation of information on a touch display, a first interface, toward the touch display, configured to receive indications of touch interactions from the touch display, and at least one processing core configured to modify contents of the representation based at least in part on signals received from a second interface comprised in the apparatus.

### FIELD OF INVENTION

The present invention relates to representing information originating in a plurality of sources on a display.

### BACKGROUND OF INVENTION

Traditionally computers have been furnished with displays, which may comprise, for example, cathode-ray tube, CRT, displays or liquid-crystal displays, LCD. In some use cases, a computer may share its display contents with a display device not permanently associated with the computer, for example a laptop may be connected to a video projector to share a presentation with a group of people. In this case, the video projector may be fed the same, or similar, video signal as the display permanently associated with the laptop. A user may simply plug a video connector of the projector to his laptop, responsive to which the laptop may start providing a copy of the video signal via the video connector to the projector.

In collaborative meetings, a presenter may share a section of his screen, or his whole screen, with his collaborators using a networked meeting software solution. For example, the presenter may share a text document and then go through elements in the document while discussing them orally over a simultaneously open voice connection with the collaborators.

In control rooms, or advertising billboards, an array of screens, for example 16 screens arranged in four rows of four screens, may be arranged as one larger display. A computer may be configured to render a single video feed to the array of screens by deriving from the single video feed individualized video feeds for each display comprised in the array. A viewer observing the array from a distance will effectively perceive one large display displaying a single image instead of 16 smaller displays arranged in an array. Alternatively, displays comprised in an array may display differing video feeds, for example where closed-circuit TV, CCTV, surveillance is performed in a control doom.

Some computers or tablet devices are operable via a touchscreen display, or touch display for short. In addition to, or alternatively to, receiving input instructions via a keyboard and/or mouse, such computers may be at least in part controllable via a touch display arranged in connection with the computer. A computer may have a touch display as it's permanently or semi-permanently associated display, as is the case with tablet devices, or a computer may be arranged to employ a touch display as a secondary, or temporary, display. For example, a computer may share a presentation via a large touch display, such that the presentation may be viewed and interacted with via the large touch display. Such sharing may be useful, for example, if a display permanently associated with the computer is too small for sharing the presentation effectively.

### SUMMARY OF THE INVENTION

According to a first aspect of the present invention, there is provided an apparatus comprising a memory configured to store information relating to a representation of information on a touch display, a first interface, toward the touch display, configured to receive indications of touch interactions from the touch display, and at least one processing core configured to modify contents of the representation based at least in part on signals received from a second interface comprised in the apparatus.

According to a second aspect of the present invention, there is provided a method comprising storing information relating to a representation of information on a touch display, receiving, over a first interface comprised in an apparatus, from the touch display, indications of touch interactions, and modifying contents of the representation based at least in part on signals received from a second interface comprised in the apparatus.

According to a third aspect of the present invention, there is provided an apparatus comprising means for storing information relating to a representation of information on a touch display, means for receiving, over a first interface comprised in an apparatus, from the touch display, indications of touch interactions, and means for modifying contents of the representation based at least in part on signals received from a second interface comprised in the apparatus

According to a fourth aspect of the present invention there is provided a non-transitory computer readable medium having stored thereon a set of computer readable instructions for causing a processor to display a list of items on an electronic device comprising the computer implemented steps of storing information relating to a representation of information on a touch display, receiving, over a first interface comprised in an apparatus, from the touch display, indications of touch interactions, and modifying contents of the representation based at least in part on signals received from a second interface comprised in the apparatus.

### INDUSTRIAL APPLICABILITY

At least some embodiments of the present invention find industrial applicability in enabling more effective manipulation of data by a collaboration of persons.

### BRIEF DESCRIPTION OF THE DRAWINGS

FIG. 1 illustrates an example system in accordance with at least some embodiments of the present invention;

FIG. 2 illustrates an example sub-representation in accordance with at least some embodiments of the present invention;

FIG. 3 illustrates an example apparatus capable of supporting at least some embodiments of the present invention;

FIG. 4 is a signalling diagram illustrating signalling in accordance with at least some embodiments of the invention, and

FIG. 5 is a flow graph of a method in accordance with at least some embodiments of the invention.

### DETAILED DESCRIPTION OF EXAMPLE EMBODIMENTS

At least some embodiments of the present invention may be used to co-operatively share a large touch display between a plurality of users and/or applications running on a plurality of source computers.

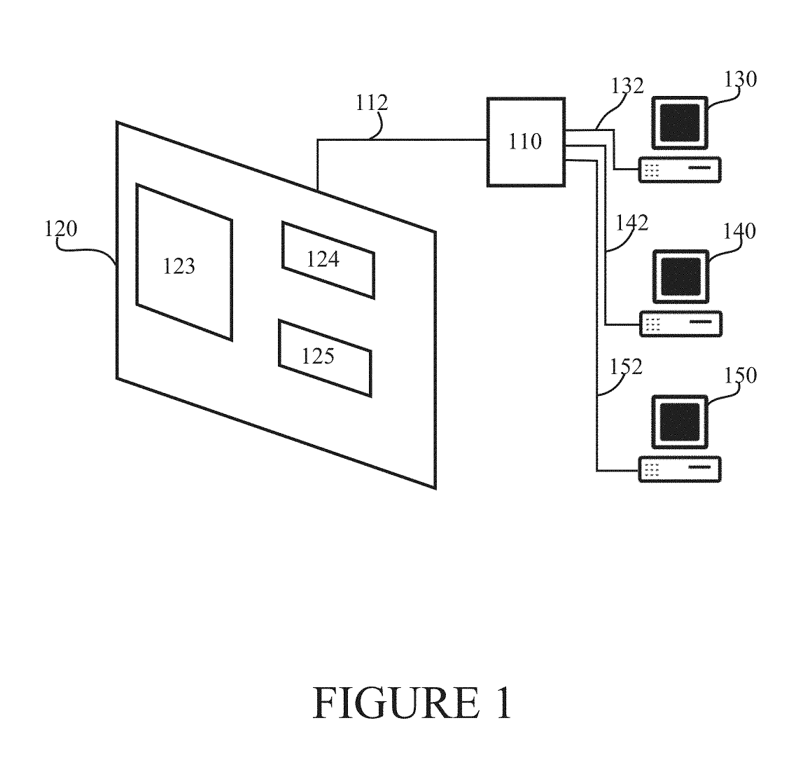

FIG. 1 illustrates an example system in accordance with at least some embodiments of the present invention. The illustrated example system may be used in collaborative editing or processing of data or representations of data, for example. The illustrated example system may be used in an office environment.

Illustrated are computers 130, 140 and 150, which may comprise, for example, laptop, desktop or tablet type computers. Not all of computers 130, 140 and 150 need to be computers of the same type. At least one of computers 130, 140 and 150 may comprise a smartphone. Each of computers 130, 140 and 150 may be configured to operate in accordance with an operating system, such as for example, Windows, iOS, Android, Linux or Symbian. Not all of computers 130, 140 and 150 need to be configured to operate in accordance with the same operating system.

Each of computers 130, 140 and 150 may be capable of operating an application. Examples of applications include word processors, presentation managers, image displays, video playback applications, spread sheet applications and videoconferencing applications.

Computers 130, 140 and 150 may be collectively referred to as source computers.

Computer 130 may be arranged to provide a video signal to computer 110 via connection 132. Connection 132 may comprise a wire-line, for example a high-definition media interface, HDMIconnection, or at least in part a wireless, such as for example a Bluetooth or wireless local area network, WLAN, connection. Connection 132 may comprise an Ethernet connection. Computer 110 may be configured to receive the video signal from computer 130.

Computer 140 may be arranged to provide a video signal to computer 110 via connection 142. Connection 142 may comprise a wire-line, for example a high-definition media interface, HDMI, connection, or at least in part a wireless, such as for example a Bluetooth or wireless local area network, WLAN, connection. Connection 142 may comprise an Ethernet connection. Computer 110 may be configured to receive the video signal from computer 140.

Computer 150 may be arranged to provide a video signal to computer 110 via connection 152. Connection 152 may comprise a wire-line, for example a high-definition media interface, HDMI, connection, or at least in part a wireless, such as for example a Bluetooth or wireless local area network, WLAN, connection. Connection 152 may comprise an Ethernet connection. Computer 110 may be configured to receive the video signal from computer 150.

Computer 110 may be arranged to receive video signals from connections 132, 142 and 152 via at least one video capture apparatus comprised in or interfaced with computer 110, wherein each of connections 132, 142 and 152 may be connected to the at least one video capture apparatus. Connections 132, 142 and 152 need not be of the same type. Video signals received over these connections may be in a video format, such as an analogue or digital video format. The video format may comprise a digital streaming video format such as flash. Connections 132, 142 and 152 may convey port identification data that allows computers 130, 140 and 150 to identify which port in computer 110 they are connected to. The port identification data may be, for example, unique within the system illustrated in FIG. 1 or globally. Such identification information can be transmitted over extended display identification data, EDID, protocol or similar when using for example DVI or HDMI wires, for example. In these cases the connection id can be embedded in the EDID device serial number field or some other field in the EDID data. The connection identifier data may be for example the number of the connection, or a globally unique bit pattern.

Computer 110, like computers 130, 140 and 150, may run an operating system, which need not be a same operating system as is run by any or any one of computers 130, 140 and 150. Computer 110 may be configured to provide a video signal to touch display 120. Touch display 120 may comprise, for example, a large touch screen display. Touch display 120 may be larger than a display permanently associated with at least one of the source computers. Touch display 120 may be enabled to display visual information and to gather touch inputs, wherein gathering touch inputs may comprise determining a position of touch display 120 that has been touched. Touch display 120 and/or computer 110 may derive coordinates of touch inputs.

At least one of computers 130, 140 and 150 may be configured to run an application that monitors the identity of at least one of connections 132, 142 and 152. The application may transmit this information to the computer 110 so that computer 110 can automatically determine the source computer of the video streams 132, 142 and 152. Without the identity information the mapping from computers 130, 140 and 150 to wire connections may need to be carried out manually.

Computer 110 may rely on external video-capture converters to capture video data from at least one of connections 132, 142 and 152. Such converters may communicate with the computer 110 via standard protocols, such as USB or Ethernet, for example.

At least one of computers 130, 140 and 150 may be configured to run an application that performs screen capture operation, encodes the captured on-screen graphics and transmits the graphics to the computer 110.

At least one of computers 130, 140 and 150 may be configured to run an application that receives touch coordinate data from the computer 110 and injects the touch events to an operating system application touch event interface. This operation may be done, for example, via virtual touch driver that communicates with the application.

Touch display 120 may be a monolithic single display, or touch display may be comprised of a plurality of smaller touch displays arranged to act together, under the control of computer 110, as a single larger effective touch display 120. Touch display 120 may be based on plasma, LCD, CRT or other suitable technology. Touch display 120 may gather touch inputs in a capacitive or resistive way, or by observing touch events using at least one camera, for example. In some embodiments, computer 110 is comprised in touch display 120.

Computer 110 may provide the video signal to touch display 120 via connection 112, which may comprise, for example a wire-line, multiple wire-lines or at least in part wireless connection. Touch display 120 may provide indications of touch inputs to computer 110 via connection 112 or via another connection.

In cases where touch display 120 is composed of multiple sub-elements, each of the elements may transmit its touch input to computer 110 separately and computer 110 may then map the input from each of the sub-elements to the correct part of the whole display 120.

Computer 110 may be configured, for example by software, to derive a representation of video signals received in computer 110 from the source computers, for displaying at least in part the information comprised in the video signals on touch display 120. Computer 110 may be configured to control touch display 120, and to allocate part of the display area of touch display 120 to video data from each source computer. In other words, where there are three source computers 130, 140 and 150, computer 110 may be configured to represent video data from each source computer on touch display 120. In the example illustrated in FIG. 1, computer 110 arranges the representation on touch display 120 so that it comprises three sub-representations 123, 124 and 125.

The contents of sub-representation 123 may be derived from a video signal received in computer 110 from source computer 130, via connection 132. The contents of sub-representation 124 may be derived from a video signal received in computer 110 from source computer 140, via connection 142. The contents of sub-representation 125 may be derived from a video signal received in computer 110 from source computer 150, via connection 152. Computer 110 may be configured to derive sub-representations from video signals received from source computers by suppressing part of the video content of the received video signal and/or adding content to sub-representations that is not present in the received video signal. For example, computer 110 may reduce a colour depth of the received video signal to derive a sub-representation with fewer colours than in the received video signal. For example, computer 110 may provide a sub-representation with separate user interface control elements not present in the received video signal.

A user of a source computer may configure his source computer to feed into computer 110 an entire screen of the source computer, or an operating system window that the user selects. In the latter case, a sub-representation on touch display 120 may comprise as content content from the selected window on the source computer, and not from other windows not selected by the user. The source computer may provide the video signal to computer 110 as a continuous video signal, allowing computer 110 to render a real-time sub-representation on touch display 120. Alternatively, the source computer may provide snapshots periodically, in which case computer 110 may store the snapshot and generate a continuous, non-moving sub-representation based on the stored snapshot. The sub-representation may then be updated in case the source computer provides a new snapshot.

A sub-representation, such as for example sub-representation 123, 124 or 125, may be furnished with user interface control elements. Such user interface control elements may relate to controlling taking place at computer 110 or at a source computer providing the content of the sub-representation. For example, where the sub-representation comprises a video playback window from a source computer, the video playback window may comprise “play” and “stop” elements. Responsive to receiving from touch display 120 indications a user has touched “stop”, for example”, computer 110 may provide a corresponding signal to the source computer so the source computer is enabled thereby the activate the “stop” user interface option. Computer 110 may provide the source computer with coordinates inside the screen or window that correspond to the touch interaction at touch display 120, for example. An application running on a source computer may thus be controllable, at least in part from touch display 120 and a user interface of the source computer itself.

Computer 110 may furnish sub-representations also with separate user interface control elements that relate to manipulating the sub-representation itself, rather than its contents via the source computer. For example, a sub-representation may comprise a terminate user interface element, touching which will terminate display of the sub-representation on touch display 120. In case computer 110 receives from touch display 120 an indication that a user has touched this element, computer 110 may cease providing the sub-representation to touch display 120. In some embodiments, computer 110 is configured to verify with a prompt that the user intended to manipulate the terminate user interface element, and did not touch it unintentionally. For example, the prompt may comprise “Terminate this window?”.

Computer 110 may furnish a sub-representation with a move user interface element. A user may, for example, press and hold the move user interface element, and holding his finger on the surface of touch display 120 drag the sub-representation to a different part of the screen of touch display 120.

Computer 110 may furnish a sub-representation with a resize user interface element. A user may, for example, press and hold the resize user interface element, and holding his finger on the resize user interface element touch and drag a secondary resize user interface element to dynamically modify a size of the sub-representation along the “pinch-to-zoom” model.

Computer 110 may modify a sub-representation, for example as described above in connection with stop, move and resize, without informing a source computer providing contents to the sub-representation. As such manipulations relate to the sub-representation itself, and not to its content, co-operation from the source computer is not needed.

Computer 110 may be configured to decide, responsive to receiving from touch display 120 an indication of a touch interaction, which of the active sub-representations the touch interaction relates to. Computer 110 may be configured to decide, whether the touch interaction relates to contents of the sub-representation or to the sub-representation itself, for example by determining whether the touch interaction involves a content area of the sub-representation or separate user interface elements provided with the sub-representation by computer 110. Responsive to determining the touch interaction relates to content, computer 110 may be configured to inform the source computer providing the content of the touch interaction, such as for example by providing coordinates of the touch interaction inside the content area. Responsive to determining the touch interaction relates to separate user interface elements provided with the sub-representation, computer 110 may be configured to modify the sub-representation based on the touch interaction without informing the source computer providing the content.

Separate user interface elements provided with the sub-representation may relate to controlling display of the sub-representation without involving the source computer. Separate user interface elements provided with the sub-representation may be provided independently of contents of a video signal from a source computer.

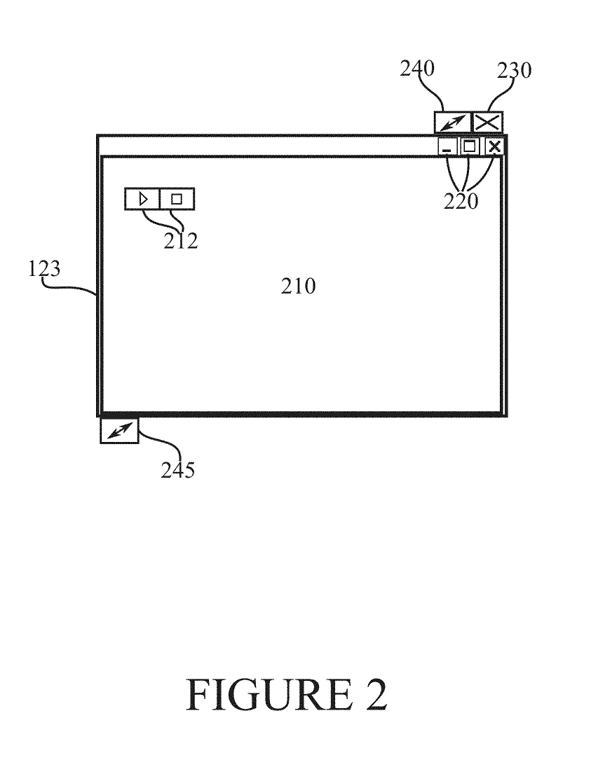

FIG. 2 illustrates an example sub-representation in accordance with at least some embodiments of the present invention. The illustrated sub-representation corresponds to sub-representation 123 of FIG. 1. Contents of sub-representation 123 may originate, via computer 110, in a source computer such as computer 130.

Sub-representation 123 comprises in the illustrated example a playback application 210, which comprises application user interface elements 212, play and stop. Responsive to a user pressing play, for example, touch display 120 may signal the coordinates of the touch interaction to computer 110, which may responsively determine, based on the coordinates, that the touch interaction relates to sub-representation 123 and its content area. Computer 110 may then provide the coordinates of the touch interaction, for example in terms of a view corresponding to a video signal received in computer 110 from source computer 130, to source computer 130 which may then activate the play user interface element in the application, running in source computer 130.

In the illustrated example, sub-representation 123 comprises source computer operating system level controls 220, which may minimize, maximize or terminate the application, running in source computer 130 providing the video signal that defines the content of sub-representation 123. Responsive to user touching one of controls 220, computer 110 may inform source computer 130 of the interaction, for example in terms of coordinates or alternatively in terms of the invoked function, such as terminate (X). Controls 220 are optional features.

In the illustrated example, sub-representation 123 is provided with separate user interface control elements 240, 245 and 230. These user interface control elements relate to controlling the sub-representation itself by computer 110. As described above, by interacting with the terminate element 230, a user can cause computer 110 to cease providing sub-representation 123 to touch display 120. This may be useful, for example where users need more space to concentrate on other sub-representations.

By interacting with user interface element 240, a user can move sub-representation 123, and the separately provided user interface control elements 230, 240 and 245, along the surface of touch display 120. For example, by touching element 240 and sweeping along the surface of touch display 120 without interrupting the touch, a user can move sub-representation 123 to a different location on touch display 120.

By interacting with user interface elements 240 and 245, a user may resize sub-representation 123. For example, by touching element 240 and, without interrupting the touch, touching element 245, the user may reduce the size of sub-representation 123 by sweeping his fingers, still touching elements 240 and 245, closer to each other. Conversely, he can enlarge sub-representation 123 by sweeping his fingers, still touching elements 240 and 245, further from each other.

Variations of the user interface control elements may be provided without departing from the scope of the present invention. For example, sub-representation 123 may be provided with a separate move user interface control element.

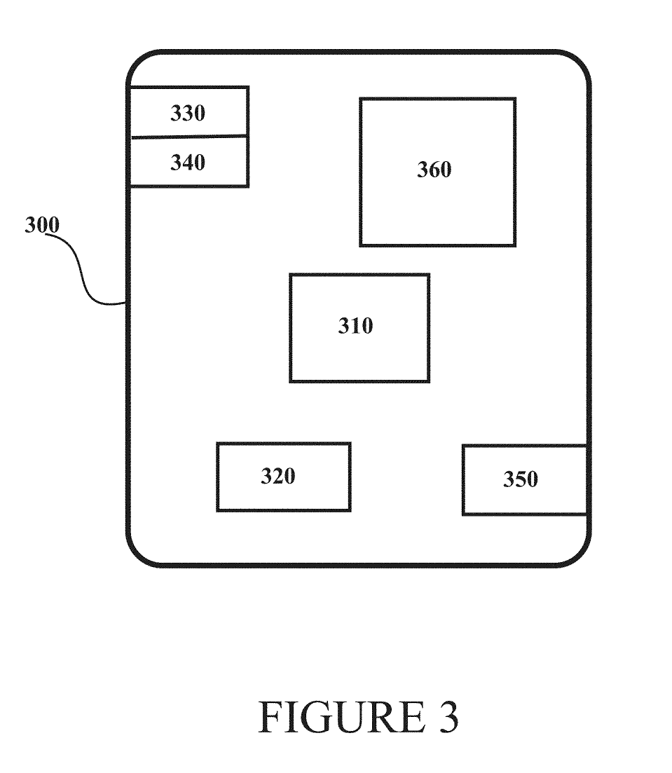

FIG. 3 illustrates an example apparatus capable of supporting at least some embodiments of the present invention. Illustrated is device 300, which may comprise, for example, computing device such as computer 110, for example. Comprised in device 300 is processor 310, which may comprise, for example, a single- or multi-core processor wherein a single-core processor comprises one processing core and a multi-core processor comprises more than one processing core. Processor 310 may comprise a Qualcomm Snapdragon 800 processor, for example. Processor 310 may comprise more than one processor. A processing core may comprise, for example, a Cortex-A8 processing core manufactured by Intel Corporation or a Brisbane processing core produced by Advanced Micro Devices corporation. Processor 310 may comprise at least one application-specific integrated circuit, ASIC. Processor 310 may comprise at least one field-programmable gate array, FPGA.

Device 300 may comprise memory 320. Memory 320 may comprise random-access memory, RAM, and/or permanent memory. Memory 320 may comprise at least one RAM chip. Memory 320 may comprise magnetic, optical and/or holographic memory. Memory 320 may be at least in part accessible to processor 310. Memory 320 may comprise computer instructions that processor 310 is configured to execute.

Device 300 may comprise a transmitter 330. Device 300 may comprise a receiver 340. Transmitter 330 and receiver 340 may be configured to transmit and receive, respectively, information in accordance with at least one standard, such as Ethernet, USB or Bluetooth. Transmitter 330 may comprise more than one transmitter. Receiver 340 may comprise more than one receiver. Transmitter 330 and/or receiver 340 may be configured to operate in accordance with Ethernet, USB, Bluetooth or Wibree, for example. Transmitter 330 and/or receiver 340 may comprise video interfaces.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to start and close programs.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a computer, it may comprise a magnetic hard disk enabled to store digital files. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

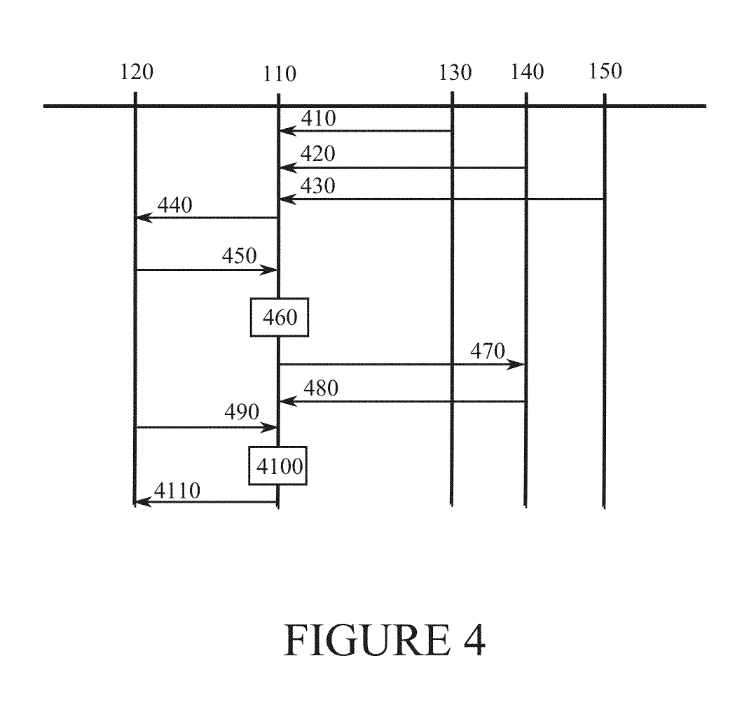

FIG. 4 is a signalling diagram illustrating signalling in accordance with at least some embodiments of the invention. On the vertical axes are illustrated, from left to right, in terms of FIG. 1, touch display 120, computer 110, and source computers 130, 140 and 150.

In phase 410, source computer 130 provides a video signal to computer 110. In phase 420, source computer 140 provides a video signal to computer 110. In phase 430, source computer 150 provides a video signal to computer 110. Phases 410, 420 and 430 may be continuous in nature, in other words the source computers may each provide a continuous video signal to computer 110.

In phase 440, computer 110 provides a video signal to touch display 120, the video signal of phase 440 comprising coded therein a representation of content from each of source computers 130, 140 and 150. The representation may comprise, corresponding to each signal from a source computer, a sub-representation.

In phase 450, computer 110 may receive from touch display 120 an indication of a touch interaction. Responsively, in phase 460, computer 110 may decide which sub-representation the touch interaction relates to and whether the touch interaction relates to the content of the sub-representation or the sub-representation itself. The latter determination may be based on determining whether the touch interaction relates to a content area of the sub-representation or to user interface elements separately provided with the sub-representation, for example. In case the touch interaction relates to the optional source computer operating system level controls 220 discussed above in connection with FIG. 2, computer 110 may consider it to relate to content.

In the illustrated example, the touch interaction indicated in phase 450 relates to content and computer so determines in phase 460. In phase 470, computer 110 may signal to source computer 140 since computer 110 in phase 460 determined that the touch interaction indicated in phase 450 relates to a sub-representation of source computer 140. Source computer 140 responsively modifies the video signal it provides to computer 110, which is illustrated as phase 480. The modification is reflected in the contents of the sub-representation computer 110 in turn provides to touch display 120. The transmission of phase 480 may be continuous in nature, much like that of phase 420. The transmission of phase 480 may take the place of the transmission of phase 420, in other words at any time source computer 140 may be configured to provide exactly one video signal to computer 110.

In phase 490, computer 110 may receive from touch display 120 an indication of a second touch interaction. Responsively, in phase 4100 computer 110 may determine that the second touch interaction relates to a sub-representation itself, rather than contents of a sub-representation. For example, the second touch interaction may comprise an instruction to move or resize a sub-representation. Responsively, computer 110 may modify the sub-representation concerned and provide to touch display 120 a video signal comprising the modified sub-representation, phase 4110. The providing of phase 4110 may be continuous in nature.

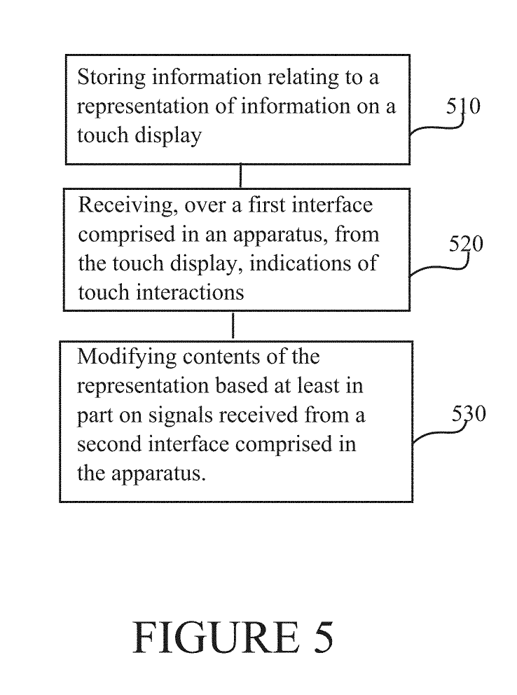

FIG. 5 is a flow graph of a method in accordance with at least some embodiments of the invention. The phases of the illustrated method may be performed in computer 110, for example.

Phase 510 comprises storing information relating to a representation of information on a touch display. Phase 520 comprises receiving, over a first interface comprised in an apparatus, from the touch display, indications of touch interactions. Finally, phase 530 comprises modifying contents of the representation based at least in part on signals received from a second interface comprised in the apparatus.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

In this document, where applicable, the term video or video signal may be taken to mean a video signal, such as a VGA signal, or a bit stream encoding visual information in general. In general, video may mean visual, where applicable.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1.-35. (canceled)

36. An apparatus comprising:
a memory configured to store information relating to a representation of information on a touch display, wherein the representation is at least in part based on video signals received via a second interface from at least two computers;
a first interface, toward the touch display, configured to receive indications of touch interactions from the touch display, and
at least one processing core configured to modify contents of the representation based at least in part on signals received from the second interface comprised in the apparatus, and responsive to deciding that the indications relate to interacting with a program running on a first computer of the at least two computers, to signal to the first computer concerning the interaction with the program, to thereby control the program.

37. The apparatus according to claim 36, wherein the second interface comprises a screen capture device configured to receive a video output of at least one computer.

38. The apparatus according to claim 36, wherein the representation comprises at least two sub-representations, contents of each sub-representation being based on a video signal from exactly one of the at least two computers.

39. The apparatus according to claim 38, wherein a first one of the at least two sub-representations is of a different size than a second one of the at least two sub-representations.

40. The apparatus according to claim 38, wherein the at least two sub-representations do not completely cover the touch display.

41. The apparatus according to claim 38, wherein the at least one processing core is configured to provide at least one of the at least two sub-representations with separate user interface elements independently of contents of the video signal from the respective one of the at least two computers.

42. The apparatus according to claim 38, wherein the at least one processing core is configured to modify the representation, based at least in part on an indication of touch interaction received in the apparatus over the first interface, by changing a size of at least one of the at least two sub-representations.

43. The apparatus according to claim 38, wherein the at least one processing core is configured to modify the representation, based at least in part on an indication of touch interaction received in the apparatus over the first interface, by moving at least one of the at least two sub-representations.

44. The apparatus according to claim 38, wherein the apparatus is further configured to associate at least one of the indications of touch interactions from the touch display with a specific computer from among the at least two computers based on identifying which sub-representation the touch interaction involves, and to transmit to the specific computer information relating to the touch interaction.

45. The apparatus according to claim 36, wherein the at least one processing core is configured to cause the apparatus to at least one of transmit and receive, via a connection of the second interface, port identification data of the connection.

46. The apparatus according to claim 45, wherein the apparatus is configured to receive the port identification data and to identify a computer transmitting the port identification data without user intervention.

47. A method comprising:
storing information relating to a representation of information on a touch display wherein the representation is at least in part based on video signals received via a second interface from at least two computers;
receiving, over a first interface comprised in an apparatus, from the touch display, indications of touch interactions, and
modifying contents of the representation based at least in part on signals received from a second interface comprised in the apparatus, and responsive to deciding that the indications relate to interacting with a program running on a first computer of the at least two computers, to signal to the first computer concerning the interaction with the program, to thereby control the program.

48. The method according to claim 47, wherein the second interface comprises a screen capture device configured to receive a video output of at least one computer.

49. The method according to claim 48, wherein the representation comprises at least two sub-representations, contents of each sub-representation being based on a video signal from exactly one of the at least two computers.

50. A non-transitory computer readable medium having stored thereon a set of computer readable instructions for causing a processor to display a list of items on an electronic device comprising the computer implemented steps of:
storing information relating to a representation of information on a touch display wherein the representation is at least in part based on video signals received via a second interface from at least two computers;
receiving, over a first interface comprised in an apparatus, from the touch display, indications of touch interactions, and
modifying contents of the representation based at least in part on signals received from a second interface comprised in the apparatus, and responsive to deciding that the indications relate to interacting with a program running on a first computer of the at least two computers, to signal to the first computer concerning the interaction with the program, to thereby control the program.
